(19) United States
(12) Patent Application Publication
(10) Pub. No.: US 2011/0206308 A1
(43) Pub. Date: Aug. 25, 2011

(54) Wheel Bearing Apparatus For A Vehicle

(75) Inventors: Kazunari Yamamoto, Iwata-Shi (JP); Takumi Yamada, Iwata-Shi (JP)

(73) Assignee: NTN Corporation, Osaka (JP)

(21) Appl. No.: 13/102,230

(22) Filed: May 6, 2011

Related U.S. Application Data
(63) Continuation of application No. PCT/JP2009/005868, filed on Nov. 5, 2009.

(30) Foreign Application Priority Data
Nov. 6, 2008 (JP) 2008-284977

(51) Int. Cl. F16C 33/58; F16C 19/08

(52) U.S. Cl. 384/513

(57) ABSTRACT

A vehicle wheel bearing apparatus has an outer member, an inner member, double row balls freely rollably contained between the inner raceway surfaces and the outer raceway surfaces, respectively, of the inner member and the outer member. The inner ring is axially secured relative to the wheel hub by a caulked portion. A tapered auxiliary raceway surface is formed on the outer circumference of the inner ring near its inner raceway surface. A chamfered portion is formed between the outer circumference and the caulked end face of the inner ring. The chamfered portion has a circular arc cross-section. The radius of curvature of the circular arc cross-section of the chamfered portion is set within a range of R1.2-R3.0 mm.

### CROSS-REFERENCE TO RELATED APPLICATIONS

This application is a continuation of International Application No. PCT/JP2009/005868, filed Nov. 5, 2009, which claims priority to Japanese Application No. 2008-284977, filed Nov. 6, 2008. The disclosures of the above applications are incorporated herein by reference.

### FIELD

The present disclosure relates to a wheel bearing apparatus that freely rotationally supports a wheel of a vehicle, such as an automobile, relative to a suspension apparatus and, more particularly, to a vehicle wheel bearing apparatus with an inner ring to be caulked onto the wheel hub that has high durability.

### BACKGROUND

Wheel bearing apparatus is used for driving wheels and driven wheels. Additionally, wheel bearing apparatus has been developed intended to be manufactured at a low cost, have a light weight and a compact size to improve fuel consumption. One representative example of such a wheel bearing apparatus for a driven wheel of the prior art is shown in FIG. 3.

This wheel bearing apparatus is a so called third generation type. It includes a wheel hub 51, an inner ring 52, an outer ring 53 and double row balls 54, 54. The wheel hub 51 is integrally formed with a wheel mounting flange 55 at its outer-side end. The wheel hub outer circumference includes an inner raceway surface 51a. A cylindrical portion 51b extends from the inner raceway surface 51a. The wheel mounting flange 55 includes hub bolts 56 equidistantly along its periphery.

The inner ring 52 is formed, on its outer circumference, with an inner raceway surface 52a. The inner ring 52 is press-fit onto the cylindrical portion 51b of the wheel hub 51. The inner ring 52 is prevented from axially coming off of the wheel hub 51 by a caulked portion 51c. The caulked portion 52c is formed by plastically deforming the end portion of the cylindrical portion 51b of the wheel hub 51 radially outward.

The outer ring 53 is formed on its outer circumference with a body mounting flange 53b. The outer ring 53 inner circumference includes double row outer raceway surfaces 53a, 53a. The double row balls 54, 54 are rollably contained between the double row outer raceway surfaces 53a, 53a and the inner raceway surfaces 51a, 52a that oppose the double row outer raceway surfaces 53a, 53a. Seals 57, 58 are mounted on both ends of the outer member 53. The seals 57, 68 prevent leakage of grease contained in the bearing and the entry of rain water and dust into the bearing from the outside.

The wheel hub 51 is integrally formed by forging a blank of carbon steel including carbon of 0.40-0.80% by weight. It is hardened by high frequency induction quenching so that a region, from the inner-side base of the wheel mounting flange 55 to the cylindrical portion 51b, is hardened. The caulked portion 51c remains as is after forging to have a surface hardness of the blank. The inner ring 52 is made of high carbon chrome steel such as SUJ2 and is hardened to its core by dip quenching.

FIG. 4 is a schematic view of a wheel bearing apparatus used for an experiment to obtain a relative relationship between the amount of expansion of the outer diameter of an inner ring and the axial force of caulking. An inner ring “c”, for examination, is shortened by cutting its smaller end portion of the actually used wheel hub 52. A load cell “d” is fit onto the inner side outer circumference of a shaft portion “b” of a wheel hub “a”. The total length of the inner ring “c”, for examination, and the load cell “d” is determined so that it corresponds to the length actually used for the inner ring 52. The axial force after caulking can be measured by the load cell “d” which includes a plurality of strain gages attached to it.

It has been found, according to such an experiment, that there is a linear relationship between the amount of expansion of the outer diameter of the inner ring “c”, for experiment, and the axial force of caulking. Thus, the caulking axial force is increased with the increase of the expansion amount of the outer diameter of the inner ring “c”, for experiment. Accordingly, the caulking axial force can be controlled from such a relative relationship by adjusting the expansion amount of the outer diameter of the inner ring “c”, for experiment. That is, it is possible to obtain a well caulked condition by easily and exactly examining whether the caulked portion 51c is in close contact with against the round chamfered portion of the inner ring 52 by knowing the caulking axial force based on the expansion amount of the outer diameter of the inner ring 52 shown in FIG. 3. See, Japanese Laid-open Patent Publication No. 13979/2003.

As described above, the outer circumference 59 and thus the outer diameter of the inner ring 52 is expanded by hoop stress caused by the expansion of the inner circumference of the inner ring due to the caulking work performed on the caulked portion 51c of the cylindrical portion 51b. Accordingly, the expansion amount of the inner ring 52 can be reduced by reducing the hoop stress by controlling the axial force applied to the caulked portion 51c of the cylindrical portion 51b.

However, there is still another problem with the generation of cracks on the inner ring 52 caused during or after the caulking work. They are caused by dents caused by mutual collision between the inner rings after machining (before mounting to the wheel hub 51) of the inner rings 52. This problem of the generation of cracks cannot necessarily be solved merely by controlling the hoop stress.

### SUMMARY

It is, therefore, an object of the present disclosure to provide a vehicle wheel bearing apparatus that can prevent the generation of cracks on the inner ring during the caulking work from dents caused by mutual collision between the inner rings. Thus, this improves the durability and reliability of the inner ring.

To achieve the object, a vehicle wheel bearing apparatus comprises an outer member formed, on its inner circumference, with double row outer raceway surfaces. An inner member includes a wheel hub and at least one inner ring. The wheel hub is integrally formed with a wheel mounting flange on its one end. The wheel hub outer circumference has an axially extending cylindrical portion. The inner ring is press-fit onto the cylindrical portion of the wheel hub. The inner member further is formed, on its outer circumference, with inner raceway surfaces that opposes the outer raceway surfaces of the outer member. Double row balls are freely rollably contained between the inner raceway surfaces and the outer raceway surfaces, respectively, of the inner member and the outer member. The inner ring is axially secured relative to the wheel hub by a caulked portion. The caulked portion is formed by plastically deforming the end of the cylindrical portion radially outward. A tapered auxiliary raceway surface is formed on the outer circumference of the inner ring near its inner raceway surface. A chamfered portion is formed between the outer circumference and the caulked end face of the inner ring. It is formed with a circular arc cross-section. The radius of curvature of the circular arc cross-section of the chamfered portion is set within a range of R1.2-R3.0 mm.

The vehicle wheel bearing apparatus has an inner ring press-fit onto the cylindrical portion of the wheel hub. It is axially secured relative to the wheel hub by a caulked portion. The caulked portion is formed by plastically deforming the end of the cylindrical portion radially outward. A tapered auxiliary raceway surface is formed on the outer circumference of the inner ring near its inner raceway surface. A chamfered portion is formed between the outer circumference and the caulked end face of the inner ring. The chamfered portion has a circular arc cross-section. The radius of curvature of the circular arc cross-section of the chamfered portion is set within a range of R1.2-R3.0 mm. Thus, it is possible to provide a wheel bearing apparatus that can suppress the generation of dents caused by mutual collision of the inner rings during the manufacturing step of the inner rings. This prevents the generation of cracks from the dents of the inner ring. Thus, this improves the durability and reliability of the inner ring.

An inclined angle between the auxiliary raceway surface and the outer circumference is set within a range of 40°-60°. This makes it possible to effectively prevent the generation of cracks of the inner ring during the caulking step without detracting from the rigidity and strength of the inner ring.

The chamfered portions each have a circular arc cross-section. The chamfered portions are formed, respectively, between the auxiliary raceway surface and the outer circumference and between the auxiliary raceway surface and the inner raceway surface. The radius of curvature of each circular arc cross-section is set within a range of R1.2-R3.0 mm. When a large moment load is applied to the bearing and the contacting angle is increased, the contact ellipse will protrude onto the auxiliary raceway surface beyond the inner raceway surface of the inner ring. However, the chamfered portions can prevent the generation of edge loads on the corners between the auxiliary raceway surface and the outer circumference and between the auxiliary raceway surface and the inner raceway surface. Thus, this improves the durability of the inner ring.

The chamfered portion between the outer circumference and the caulked end face is smoothly connected via the circular arc cross-section, with a tangential angle in a range of 5°-30°, formed between the outer circumference and the circular arc cross section of the chamfered portion. This makes it possible to prevent stress concentration at the corner of the chamfered portion.

The inner member includes the wheel hub and the inner ring. The wheel hub is integrally formed with a wheel mounting flange on its one end. The wheel hub outer circumference includes the inner raceway surface that opposes one of the double row outer raceway surfaces of the outer member. The cylindrical portion axially extends from the inner raceway surface. The inner ring is press-fit onto the cylindrical portion of the wheel hub. The inner ring outer circumference includes the inner raceway surface that opposes the other of the outer raceway surfaces.

The vehicle wheel bearing apparatus of the present disclosure comprises an outer member formed, on its inner circumference, with double row outer raceway surfaces. An inner member includes a wheel hub and at least one inner ring. The wheel hub is integrally formed with a wheel mounting flange on its one end. The wheel hub outer circumference has an axially extending cylindrical portion. The inner ring is press-fit onto the cylindrical portion of the wheel hub. The inner member outer circumference further includes the inner raceway surface that opposes the outer raceway surfaces of the outer member. Double row balls are freely rollably contained, via cages, between the inner raceway surfaces and the outer raceway surfaces, respectively, of the inner member and the outer member. The inner ring is axially secured relative to the wheel hub by a caulked portion. The caulked portion is formed by plastically deforming the end of the cylindrical portion radially outward. A tapered auxiliary raceway surface is formed on the outer circumference of the inner ring near its inner raceway surface. A chamfered portion is formed between the outer circumference and the caulked end face of the inner ring. The chamfered portion has a circular arc cross-section. The radius of curvature of the circular arc cross-section of the chamfered portion is set within a range of R1.2-R3.0 mm. Thus, it is possible to provide a wheel bearing apparatus that can suppress the generation of dents caused by mutual collision during the manufacturing step of the inner ring. Also, it prevents the generation of cracks from the dents of the inner ring. Thus, this improves the durability and reliability of the inner ring.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal section view of a preferred embodiment of a vehicle wheel bearing apparatus.

FIG. 2 is an enlarged view of an inner ring of FIG. 1.

FIG. 3 is a longitudinal section view of a prior art vehicle wheel bearing apparatus.

FIG. 4 is a schematic view of a wheel bearing apparatus used for an experiment to obtain a relative relationship between the amount of expansion of the outer diameter of an inner ring and the axial force of caulking.

### DETAILED DESCRIPTION

A bearing apparatus for a wheel of vehicle comprises an outer member, formed on its outer circumference, with a body mounting flange to be mounted on a knuckle. The outer member inner circumference includes double row outer raceway surfaces. An inner member includes a wheel hub and at least one inner ring. The wheel hub is integrally formed with a wheel mounting flange on its one end. The wheel hub outer circumference has an axially extending cylindrical portion. The inner ring is press-fit onto the cylindrical portion of the wheel hub via a predetermined interference. The inner member outer circumference further includes an inner raceway surface that opposes the outer raceway surfaces of the outer member. Double row balls are freely rollably contained between the inner raceway surfaces and the outer raceway surfaces, respectively, of the inner member and the outer member. The inner ring is axially secured relative to the wheel hub by a caulked portion. The caulked portion is formed by plastically deforming the end of the cylindrical portion radially outward. A tapered auxiliary raceway surface, with an inclined angle set within a range of 40°-60°, is formed on the outer circumference of the inner ring near its inner raceway surface. Chamfered portions, each having a circular arc cross-section, are formed, respectively, between the auxiliary raceway surface and the outer circumference and between the auxiliary raceway surface and the inner raceway surface. The chamfered portion between the outer circumference and the caulked end face of the inner ring is formed with a circular arc cross-section. The radius of curvature of the circular arc cross-section of the chamfered portion is set within a range of R1.2-R3.0 mm.

A preferable embodiment of the present invention will be hereinafter described with reference to the drawings.

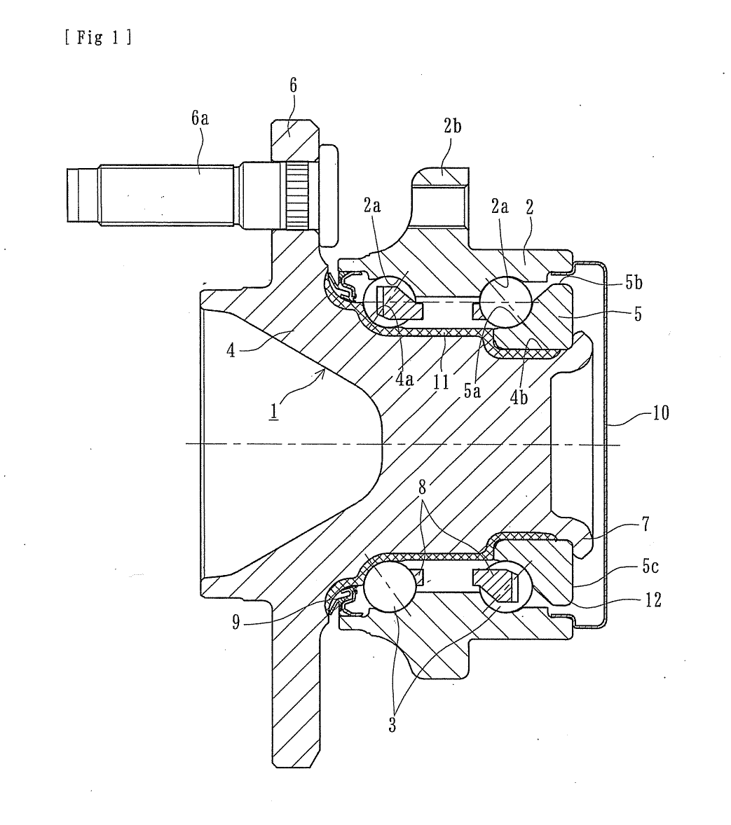

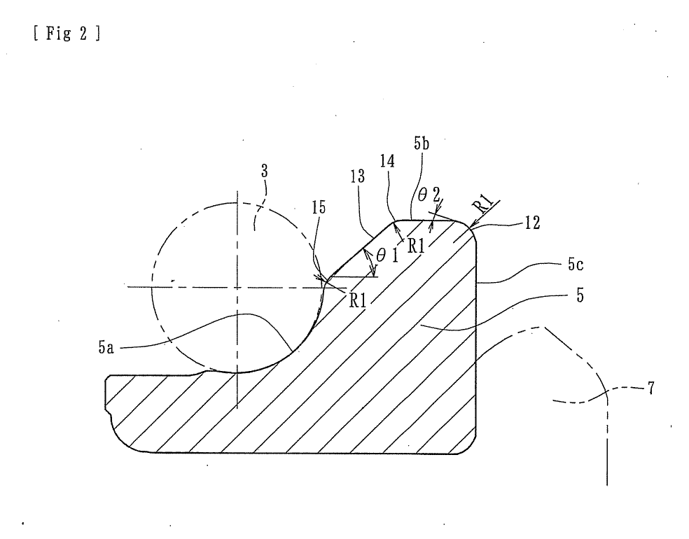

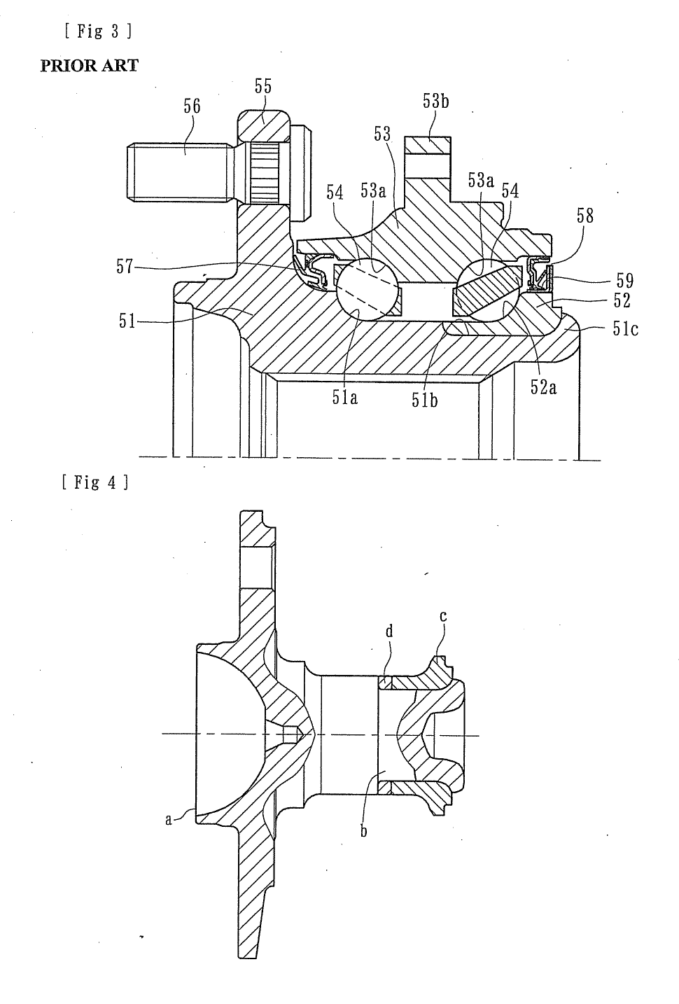

FIG. 1 is a longitudinal section view of a preferred embodiment of a vehicle wheel bearing apparatus. FIG. 2 is an enlarged view of an inner ring of FIG. 1. In the description below, a distal side of a wheel bearing apparatus when it is mounted on a vehicle is referred to as the “outer side” (a left side in FIG. 1). The proximal side of a wheel bearing apparatus is referred to as the “inner side” (a right side in FIG. 1).

The vehicle wheel bearing apparatus of the present disclosure shown in FIG. 1 is a third generation type used for a driven wheel. The bearing apparatus includes an inner member 1, an outer member 2, and double row rolling elements (balls) 3, 3 rollably contained between the inner and outer members 1, 2. The inner member 1 includes the wheel hub 4 and an inner ring 5 press-fit onto the wheel hub 4 via a predetermined interference.

The wheel hub 4 is integrally formed with a wheel mounting flange 6 at its outer-side end. Hub bolts 6a are arranged equidistantly along its periphery. The wheel hub 4 is formed on its outer circumference with one (outer-side) inner raceway surface 4a. A cylindrical portion 4b extends from the inner raceway surface 4a. An inner ring 5, with the other (inner side) inner raceway surface 5a on its outer circumference, is press-fit onto the cylindrical portion 4b, via a predetermined interference. The inner ring 5 is axially secured on the wheel hub under a predetermined bearing pre-pressure by a caulked portion 7. The caulked portion 7 is formed by plastically deforming the end of the cylindrical portion 4b radially outward.

The outer member 2 is integrally formed, on its outer circumference, with a body mounting flange 2b to be mounted on a body (not shown) of a vehicle. The outer member inner circumference includes outer raceway surfaces 2a, 2a. Double row rolling elements (balls) 3, 3 are contained between the outer and inner raceway surfaces 2a, 2a and 4a, 5a. The rolling elements 3, 3 are rollably held by cages 8, 8. Seal 9 and a cover 10 are mounted within annular opening spaces formed between the outer member 2 and the inner member 1. The seal 9 and cover 10 prevent leakage of grease contained in the bearing and entry of rain water and dust into the bearing from the outside.

Although the structure shown here is a wheel bearing apparatus for a driven wheel of a so called third generation type, where the inner raceway surface 4a is directly formed on the outer circumference of the wheel hub 4, the present disclosure is not limited to only such a structure. It is possible to apply the present disclosure to a wheel bearing apparatus of the first or second generation type where a pair of inner rings is press-fit onto the cylindrical portion of the wheel hub. In addition, although the wheel bearing apparatus is shown using double row angular contact ball bearings, using balls as rolling elements 3, 3, it is possible to use a double row tapered roller bearing using tapered rollers as the rolling elements.

The wheel hub 4 is made of medium-high carbon steel including carbon of 0.40-0.80% by weight such as S53C. The wheel hub 4 includes a hardened layer 11 (shown by cross-hatchings) formed by high frequency induction quenching. Thus, a region, including the outer side inner raceway surface 4a from a seal-land portion, which slidably contacts the seal 9, to the cylindrical portion 4b, is hardened to have a surface hardness of 50-64 HRC. The caulked portion 7 remains as a non-hardened portion, after forging, having its blank surface hardness of 25 HRC or less. On the other hand, the inner ring 5 and the rolling elements 3 are made of high carbon chrome steel such as SUJ2. They are hardened to their cores by dip quenching to have a surface hardness of 58-64 HRC.

Similar to the wheel hub 4, the outer member 2 is made of medium-high carbon steel including carbon of 0.40-0.80% by weight such as S53C. At least the double row outer raceway surfaces 2a, 2a are hardened to have a surface hardness of 50-64 HRC.

The applicant of the present disclosure has examined and analyzed dents caused by mutual collision of the inner rings 5 and noticed a relationship between the dents and the hoop stress caused by the caulking step and then thoroughly investigated causes of cracks caused on the inner rings 5 during or after the caulking. As a result, it was found that the cracks from the dents are generated on a chamfered portion 12 between the outer circumference 5b and the larger end face (i.e. caulked end face) 5c of the inner ring 5. The hoop stress caused by the caulking is increased as shown in the enlarged drawing of FIG. 2.

The applicant has found that the disclosed inner ring 5 does not easily cause dents on the inner rings due to mutual collision between them during their manufacturing steps. Also, it was noticed that it is necessary to reduce the depth of the dents even though their area is large in order to reduce the generation of cracks on the inner rings 5 due to the fact that the hoop stress is maximized on the outer circumference 5b of the inner ring 5.

The applicant formed a dent on the chamfered portion 12 of the inner ring 5 and measured a tip round of the dent and a stress generated therein. As a result, the applicant has found that the smaller the tip round of each dent, the larger the stress intensity factor. Thus, the major principal stress is increased relative to the hoop stress generated on the inner ring 5 after caulking. That is, since the tip round is transcribed to the circular arc surface on the chamfered portion 12 and furthermore to chamfered portions 14, 15 formed, respectively, between the auxiliary raceway surface 13 and the outer circumference 5b and between the auxiliary raceway surface 13 and the inner raceway surface 5a, it is effective to increase the radius of curvature of each of the chamfered portions 12, 14, 15 to suppress the generation of cracks on the inner ring 5.

According to the present disclosure the tapered auxiliary raceway surface 13 is formed on the outer circumference 5b of the inner ring 5 near its inner raceway surface 5a. The chamfered portions 14, 15 are formed, respectively, between the auxiliary raceway surface 13 and the outer circumference 5b and between the auxiliary raceway surface 13 and the inner raceway surface 5a. Each of the chamfered portions 14, 15 has a circular arc cross-section with a radius of curvature R1. The inclined angle θ 1 between the auxiliary raceway surface 13 and the outer circumference 5b is set within a range of 40°-60°, preferably of 40°-50°. This makes it possible to suppress the generation of dents caused by mutual collision of the inner rings 5 during their manufacturing steps. In this case, if the inclined angle θ 1 is set larger than 60°, the suppressing effect of dent generation will be detracted. On the other hand, if the inclined angle θ 1 is set less than 40°, a width in the axial direction of the outer circumference 5b is reduced. Accordingly, it is difficult to keep a space for mounting a seal in a case requiring the seal. Additionally, the rigidity and strength of the inner ring 5 will be reduced since the volume of material for sustaining the hoop stress is reduced. Thus, cracks are more easily generated. In this specification the term “auxiliary raceway surface” means a portion smoothly extending from a curved line of the circular arc forming a cross-section of the inner raceway surface 5a. The cross-section is formed by a curved line or a straight line having a curvature smaller than that of the circular arc forming the inner raceway surface 5a.

When a large moment load is applied to the bearing and the contacting angle is increased, the contact ellipse will protrude to the auxiliary raceway surface 13 beyond the inner raceway surface 5a of the inner ring 5. However, since the chamfered portions 14, 15, having a circular arc cross-section with a radius of curvature R1, are formed between the auxiliary raceway surface 13 and the outer circumference 5b and between the auxiliary raceway surface 13 and the inner raceway surface 5a, it is possible to prevent the generation of edge loads on the corners and thus improve the durability of the inner ring 5.

Furthermore, the applicant made samples having different radius of curvatures R1 of the circular arc cross-section of the chamfered portions 12 of the inner rings 5 and carried out the cracking test of the inner ring 5 during caulking. The results of which are shown in Table 1. As can be seen from Table 1, cracking is not present if the radius of curvature R1 of the circular arc cross-section of the chamfered portion 12 is larger than R1.2 or more. Accordingly, in the present disclosure, the radius of curvature R1 of the circular arc cross-section of the chamfered portion 12 is set within a range R1.2-R3.0 mm. The larger the radius of curvature R1 of the circular arc cross-section, the larger the area of the dent as well as the smaller the depth of dent. Accordingly, the depth of the dent becomes small and thus advantageous for the durability of the inner ring 5. On the contrary if the radius of curvature R1 of the circular arc cross-section of the chamfered portion 12 exceeds R3.0, the width of the outer circumference 5b is unacceptably reduced. It may be possible to have the width of the inner ring 5 large to set the radius of curvature R1 of the circular arc cross-section of the chamfered portion 12 large. However, this increases the weight not only of the inner ring 5 but also of the wheel hub 4. Thus, this unacceptably prevents the reduction of the weight and size of the bearing apparatus.

TABLE 1

| | Radius of curvature of | | | | |
|---|---|---|---|---|---|
| | chamfered portion R1 | | | | |
| | R1.0 | R1.1 | R1.2 | R1.3 | R1.4 |
| Any generation of crack | x | Δ | ∘ | ∘ | ∘ |
| on the inner ring? | | | | | |

x: Generation of crack
Δ: Partial generation of crack
∘: No generation of crack

In order to prevent stress concentration in the corner of the chamfered portion 12, the chamfered portion 12 is smoothly connected via the circular arc cross-section. A tangential angle (θ2) in a range of 5°-30°, preferably 15°±5° is formed between the outer circumference 5b and the circular arc cross section of the chamfered portion 12. This makes it possible to provide a vehicle wheel bearing apparatus that can prevent the generation of cracks on the inner ring 5 during the caulking work from dents caused by mutual collision between the inner rings 5. Thus, this improves the durability and reliability of the inner ring 5.

The vehicle wheel bearing apparatus of the present disclosure can be applied to any of the bearing apparatus of the first through third generation types with a self-retaining structure where the inner ring is press-fit onto the cylindrical portion of the wheel hub and axially secured thereon by plastically deforming the end of the cylindrical portion.

The present disclosure has been described with reference to the preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A vehicle wheel bearing apparatus comprising:
an outer member formed, on its inner circumference, with double row outer raceway surfaces;
an inner member includes a wheel hub and at least one inner ring, the wheel hub is integrally formed with a wheel mounting flange on its one end, the wheel hub outer circumference has an axially extending cylindrical portion, the inner ring is press-fit onto the cylindrical portion of the wheel hub, and the inner member outer circumference further includes double row inner raceway surfaces that opposes the outer raceway surfaces of the outer member;
double row balls are freely rollably contained, via cages, between the inner raceway surfaces and the outer raceway surfaces, respectively, of the inner member and the outer member;
the inner ring is axially secured relative to the wheel hub by a caulked portion that is formed by plastically deforming the end of the cylindrical portion radially outward;
a tapered auxiliary raceway surface is formed on the outer circumference of the inner ring near its inner raceway surface, a chamfered portion is formed between the outer circumference and the caulked end face of the inner ring, the chamfered portion has a circular arc cross-section, and a radius of curvature of the circular arc cross-section of the chamfered portion is set within a range of R1.2-R3.0 mm.

2. The vehicle wheel bearing apparatus of claim 1, wherein an inclined angle between the auxiliary raceway surface and the outer circumference is set within a range of 40°-60°.

3. The vehicle wheel bearing apparatus of claim 1, wherein chamfered portions, each having a circular arc cross-section, are formed, respectively, between the auxiliary raceway surface and the outer circumference and between the auxiliary raceway surface and the inner raceway surface, and wherein a radius of curvature of each circular arc cross-section is set within a range of R1.2-R3.0 mm.

4. The vehicle wheel bearing apparatus of claim 3, wherein the chamfered portion between the outer circumference and the caulked end face is smoothly connected via the circular arc cross-section, having a tangential angle in a range of 5°-30°, formed between the outer circumference and the circular arc cross section of the chamfered portion.

5. The vehicle wheel bearing apparatus of claim 1, wherein the inner member comprises the wheel hub and the inner ring, the wheel hub is integrally formed with a wheel mounting flange on its one end and its outer circumference includes the inner raceway surface that opposes one of the double row outer raceway surfaces of the outer member and the cylindrical portion axially extends from the inner raceway surface, the inner ring is press-fit onto the cylindrical portion of the wheel hub, the inner ring outer circumference includes the other inner raceway surfaces that opposes to the other of the outer raceway surfaces.
